(19) United States
(12) Patent Application Publication
(10) Pub. No.: US 2018/0229439 A1
(43) Pub. Date: Aug. 16, 2018

(54) MOUNTING DEVICE

(71) Applicant: JENOPTIK Automatisierungstechnik GmbH, Jena (DE)

(72) Inventors: Andreas BUECHEL, Kahla (DE); Wilfried KRAEMER, Jena (DE); Christon MANZELLA, Waterford, MI (US)

(21) Appl. No.: 15/749,920

(22) PCT Filed: Aug. 2, 2016
(86) PCT No.: PCT/DE2016/100351

§ 371 Date: Feb. 2, 2018

(30) Foreign Application Priority Data
Aug. 3, 2015 (DE) 10 2015 112 699.0

(51) Int. Cl. B29C 65/00; B29C 65/16; B29C 65/78

(52) U.S. Cl. CPC B29C 66/843; B29L 2031/3044; B29C 65/1635; B29C 65/1654; B29C 65/7841; B29C 66/112; B29C 66/131; B29C 66/532; B29C 66/61; B29C 66/81267; B29C 66/8167; B29C 66/8221; B29C 66/8322; B29C 66/836; B29C 66/8412; B29C 65/167

(57) ABSTRACT

The invention relates to a mounting device for the simultaneous welding of a plurality of sensor holders along a horizontal line of a bumper. Said mounting device can be adapted to different dimensions of bumpers and has one or two freely radiating diode lasers for each sensor holder. A holding-down element is arranged downstream thereof in the direction of emission, which includes a gripper for receiving the sensor holder and a holding-down element for introducing a contact pressure, said holding-down element being permeable in partial areas for the laser radiation of the diode laser.

### RELATED APPLICATIONS

The present application is a U.S. National Stage application of International PCT Application No. PCT/DE2016/100351 filed on Aug. 2, 2016 which claims priority benefit of German Application No. DE 10 2015 112 699.0 filed on Aug. 3, 2015, the contents of each are incorporated by reference in their entirety.

### FIELD OF THE INVENTION

The invention relates to a mounting device for attaching small parts, e.g. sensor holders for parking assistance sensors or distance sensors, to large-surface, three-dimensional plastic parts, e.g. bumpers.

Mounting devices of this type are used in the automotive industry, where mass production is common and short cycle times for the individual production steps are a top priority.

### BACKGROUND OF THE INVENTION

In order to achieve a short cycle time for mounting sensor holders on a bumper, the sensor holders to be attached are mounted simultaneously. Bumpers of different vehicle types are similar in shape but differ in dimensions. With respect to a center line extending vertically to a bumper mounted on the vehicle, they are basically symmetrical, but have different lengths, in particular when adapted to different vehicle widths. They are angled at their ends, and the angles between the respectively formed central piece and the end pieces may differ according to the vehicle type. Usually, the sensors and, consequently, the sensor holders are arranged on a straight line perpendicular to the center line. Again, the number of sensors and, thus, sensor holders and their distances from each other may differ depending on the vehicle type.

US 2014/0150978 A1 discloses a welding device allowing several parts to be mounted simultaneously on a bumper.

The device comprises a workbench with a holding fixture for a bumper arranged thereon. The holding fixture is adapted to the contour of the bumper, thus acting as an abutment against the contact pressure of the bumper. A cover is arranged above the holding fixture, which cover consists of a frame and transparent cover plates and, in a lowered position, presses a bumper supported on the holding fixture against the latter, as well as forming a space which is closed at the top. Inside the closed space, tools mounted on the frame are arranged. When the cover is lowered, said tools are moved from a waiting position into a working position, thus approaching the bumper.

In another embodiment, the holding fixture does not have a closed surface as a counterpiece for the bumper, but is formed by several individual supports, each arranged opposite a respective tool attached to the frame. The tools are movable to the extent required to achieve a respective welded joint.

It is not disclosed where and how parts to be welded to the bumper are pressed against the latter during welding, in order to generate a required welding pressure.

It is an object of the invention to provide a mounting device by which several sensor holders can be simultaneously welded to a bumper under contact pressure.

Preferably, the mounting device is to be adaptable to different dimensions of bumpers, in particular their different longitudinal axes and different distances of the sensor holders from each other and from a center axis of the bumper.

### OBJECT OF THE INVENTION

The object of the invention is achieved by a mounting device comprising the features of claim 1. Advantageous embodiments are disclosed in the subclaims.

### BRIEF DESCRIPTION OF THE DRAWINGS

The invention will be explained in more detail below with reference to drawings, wherein:

FIG. 1 shows an internal perspective view of a bumper with mounted sensor holders,

FIG. 2 shows a schematic diagram of a first embodiment of a mounting device with a first embodiment of a hold-down device,

FIG. 3 shows a second embodiment of a hold-down device and

FIG. 4 shows a second embodiment of a mounting device.

### DESCRIPTION OF THE EMBODIMENTS

There were certain predefined basic parameters for the design of a mounting device according to the invention in terms of shape, dimension and material of the bumpers 1 and the sensor holders 2.

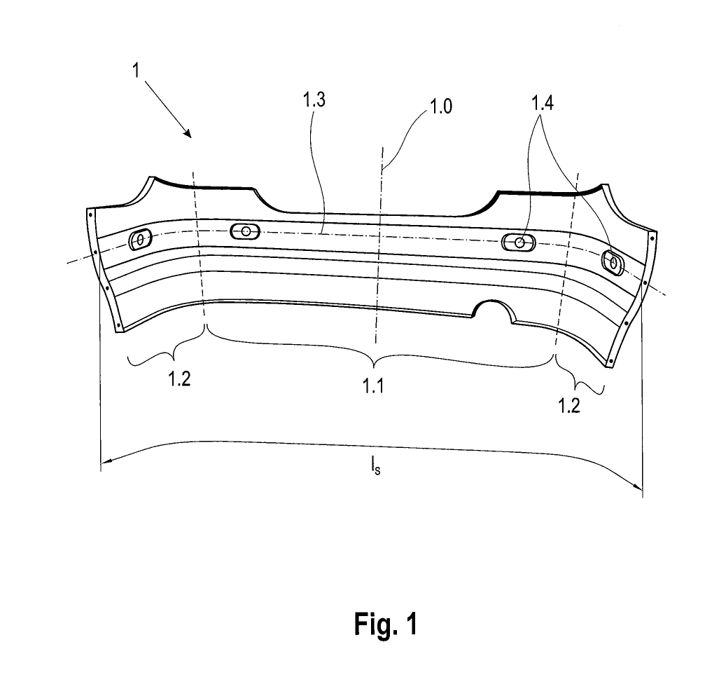

As mentioned in the introduction, a bumper 1, see FIG. 1, is a large-surface, three-dimensional plastic part. Based on a typical mounting position of a bumper 1 mounted to a vehicle, said bumper 1 has a vertical line 1.0 over a height and—over a bumper length l_{S} determined mainly by the width of the vehicle—a horizontal line 1.3 as an intersection line of a horizontal plane with the bumper 1 mounted to the vehicle. The bumper 1 is designed symmetrically with respect to the vertical line 1.0.

The bumpers 1 of different vehicles, as much as they may differ in design, are at least almost identical in the shape of their horizontal line 1.3. The latter is planar, or has a slightly convex curvature, if any, over a central piece 1.1 terminating in two end pieces 1.2 which, in many cases, are angled with respect to the central piece 1.1. The length of the central piece 1.1 and the lengths of the two end pieces 1.2, which jointly form the bumper length l_{S}, as well as the angles which the end pieces 1.2 respectively enclose with the central piece 1.1, may differ from each other to the extent to which the widths and shapes of the vehicles may differ from each other. Bumpers 1 are usually made of plastics and, thus, well-suited for fastening parts to them by means of transmission welding methods.

In order to fasten sensors to a bumper 1, holes 1.4 are formed in the bumper 1 according to the envisaged number and positions of the sensors, behind or in which holes 1.4 sensor holders 2 are attached in respective welding positions 4.1.

The device according to the invention is designed to be used for arranging and welding sensor holders 2 in a bumper 1 prepared in this manner.

The sensor holders 2 consist of a hollow cylinder 2.1 with a cylinder axis 2.1.1 and a mounting plate 2.2 enclosing the hollow cylinder 2.1 and arranged perpendicular to the latter. They are made completely or partly, at least in partial areas of the mounting plate 2.2, from a material which is transparent for laser radiation.

The mounting device according to the invention is adapted to these basic parameters.

Regardless of the different possible embodiments, the mounting device comprises a workbench 3 with a holding fixture 4, arranged thereat or thereon, for a bumper 1, and a frame 5 which is adjustable to the holding fixture 4.

The term workbench 3 is meant in the broadest sense here to refer to a basis with respect to which the holding fixture 4 is fixed and a processing unit 9 is arranged to be movable towards the holding fixture 4, between a resting position and a working position.

While the workbench 3 and the holding fixture 4 are basically required to operate the mounting device, they need not be regarded as strictly belonging to the mounting device.

The processing unit 9 is the centerpiece of the mounting device. It includes the frame 5, which has a frame length l_{G}, and as many spacers 7 as there are welding positions 4.1, each spacer 7 being positioned opposite one of the welding positions 4.1 in a working position of the frame 5.

The spacers 7 have freely radiating diode lasers 6 arranged thereon.

The frame length l_{G} is understood to be the extent of the frame 5 in the direction of the horizontal line 1.3 of a bumper 1 placed in the holding fixture 4 when the frame 5 is in the working position.

The welding positions 4.1 are the positions in which the holes 1.4 are located on the holding fixture 4 when the bumper 1 is placed on the latter and in alignment with which holes 1.4 the sensor holders 2 are welded so that the hole axes are aligned with the cylinder axes 2.1.1 of the sensor holders 2. Advantageously, the hollow cylinders 2.1 protrude through the mounting plates 2.2, with an external diameter slightly smaller than the internal diameter of the holes 1.4, so that the sensor holders 2 can be inserted in the holes 1.4. The holes 1.4 are basically introduced in a mirror-symmetrical fashion, starting from the vertical line 1.0, at predetermined distances along the horizontal line 1.3. These distances may differ for the bumpers 1 of different vehicles. Their number may also differ. Typically, four or six sensor holders 2 are mounted. The horizontal line 1.3 need not strictly be a center line dividing the bumper 1 lengthwise into parts of identical width, especially because nowadays bumpers 1 are hardly ever designed symmetrically with respect to a horizontal line 1.3.

The spacers 7 attached to the frame 5 each have a spacer axis 7.1 along which, towards the free end thereof, one or two diode lasers 6, respectively, and a hold-down device 8 are arranged behind each other in an emission plane.

The hold-down devices 8 each have a gripper 8.1, preferably a centering pin, for insertion into the hollow cylinder 2.1 of one of the sensor holders 2 and a hold-down element 8.2 designed to contact the mounting plate 2.2 thereof, wherein the hold-down elements 8.2 are transparent, at least in some areas, for the laser radiation emitted by the diode lasers 6.

In a rest position of the processing unit 9, the sensor holders 2 are picked up by the grippers 8.1 by fitting the sensor holders 2 onto the grippers 8.1 by means of the hollow cylinder 2.1. In doing so, the hold-down element 8.2 is applied against the mounting plate 2.2 of the sensor holder 2. The cylinder axis 2.1.1 of the sensor holder 2 and the axis of the gripper 8.1, which are in alignment with the spacer axis 7.1, coincide and extend perpendicularly through the center of the hole 1.4 when the processing unit 9 is in its working position.

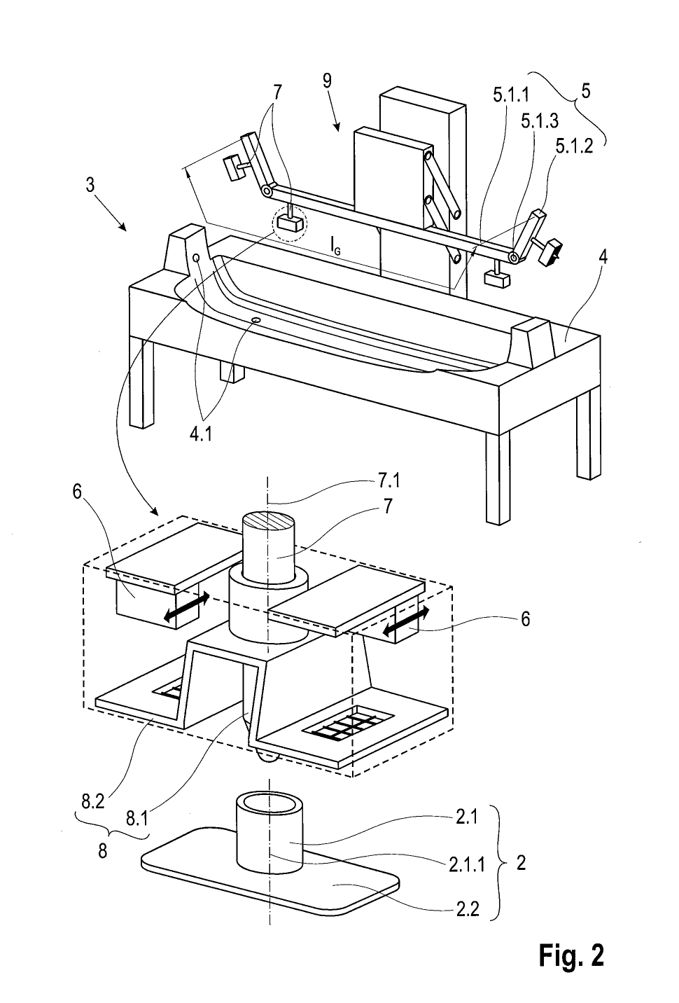

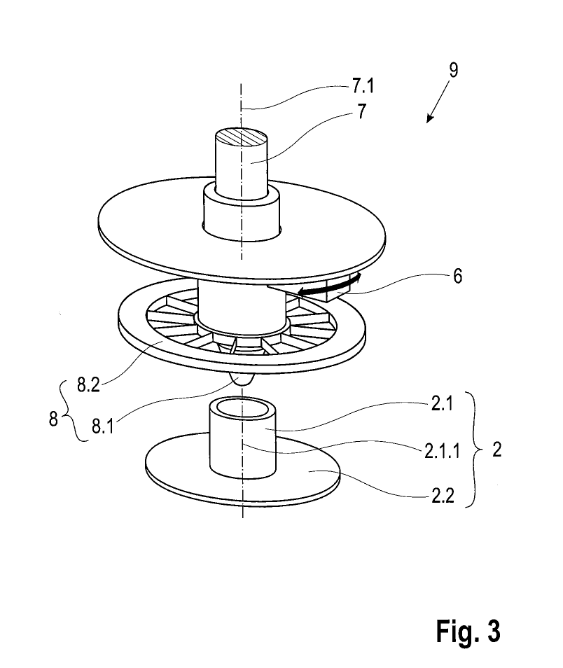

In the working position, the processing unit 9 is pressed against the holding fixture 4, with the hold-down elements 8.2 pressing directly on the mounting plates 2.2 of the sensor holders 2, so that the latter are pressed, with a contact pressure required for welding, onto the bumper 1 held in the holding fixture 4. In order to allow a laser radiation emitted by the diode lasers 6 to impinge on the mounting plates 2.2, the hold-down elements 8.2 are transmissive for the laser radiation in partial areas. Said partial areas may be formed by a transparent material or by windows, with or without an internal lattice structure. For full illumination of said partial areas with laser radiation, a diode laser 6 may theoretically emit radiation in a planar manner, with an adapted aperture, but this would require very high laser power. Practically, the diode laser 6 used is a line array of laser diodes emitting a laser line which is passed over the partial areas. For this purpose, the diode laser 6 is attached to the spacer 7 so as to movable horizontally. According to the exemplary embodiments of the hold-down device 8 shown in FIG. 2 and FIG. 3, two diode lasers 6 are either movable in a linear manner, in a direction perpendicular to the orientation of the line array, or a diode laser 6 is rotatable about the spacer axis 7.1, in order to sweep an area, in both cases, in which the sensor holder 2 is welded to the bumper 1.

The spacers 7 each have a length allowing all fitted sensor holders 2 to contact the bumper 1 simultaneously.

Advantageously, the hold-down devices 8 are spring-mounted with respect to the spacers 7, allowing the contact pressure to be incrementally increased via the feed travel and tolerances to be compensated for.

The spacers 7 may advantageously be adaptable also via their length, e.g. by designing them as telescopic rods, in order to adapt the processing unit 9 to different bumpers 1, for which the horizontal line 1.3 differs from a straight line.

The spacers 7 may also be embodied entirely or partially by a lifting cylinder. Electro-mechanical lifting cylinders are particularly suitable for this purpose, as are hydraulic or pneumatic cylinders by which a pressure can be generated in the direction of the spacer axis 7.1.

In order to be able to process different bumpers 1, the holding fixture 4 is exchangeable with other holding fixtures 4, which are respectively adapted in contour to another bumper 1, so that the bumper 1 is supported at least in the areas around the holes 1.4 and the holding fixture 4 acts as an abutment against the contact pressure of the processing unit 9. The frame 5 is accordingly variable in its frame length l_{G} so as to allow it to be adapted to the different holding fixtures 4, with the spacers 7 mounted so as to be displaceable with respect to each other on or with the frame 5.

In the simplest case, as shown in FIG. 1, the frame 5 may be formed by a central rod 5.1.1 and two end rods 5.1.2 angled with respect to the central rod 5.1.1, wherein the central rod 5.1.1 and the end rods 5.1.2 may also be formed in one piece. The processing unit 9 can only be adapted to different bumpers 1 by attaching the spacers 7 to the frame 5 at different positions along the frame length l_{G} which correspond to the respective welding positions 4.1.

Advantageously, the central rod 5.1.1 is connected to the end rods 5.1.2 via a respective articulated joint 5.1.3, thus allowing for the usual shape of the bumpers 1, some of which have strongly angled end pieces 1.2 also provided with holes 1.4 for mounting sensor holders 2. Adjusting the angle which the central rod 5.1.1 respectively encloses with the end rods 5.1.2 ensures that the spacer axes 7.1, which are directed towards the end rods 5.1.2, extend perpendicular to the bumper 1 in the working position.

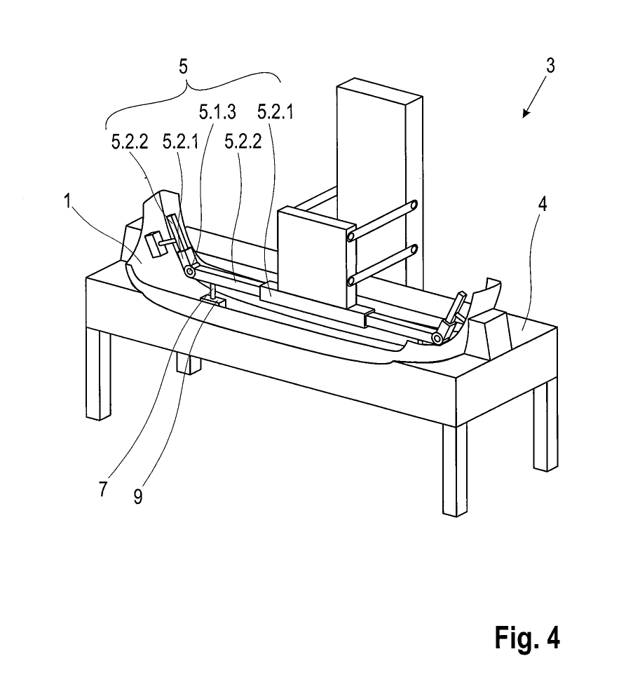

Alternatively, as shown in FIG. 4, the frame 5 may be formed by a telescopic rod system for flexible adjustment to different bumpers 1: In a simple embodiment, the frame 5 comprises, instead of the central rod 5.1.1, a telescopic rod formed of three rods, namely a central hollow cylinder rod 5.2.1 and two cylinder rods 5.2.2 coaxially guided therein in opposite directions. Instead of the end rods 5.1.2, the frame 5 includes telescopic rods, each comprising two rods, namely a hollow cylinder rod 5.2.1 and a cylinder rod 5.2.2 guided therein. Each telescopic rod may also be formed by more than two or three rods, respectively, guided within one another. Due to the spacers 7 respectively being mounted to one of the rods, they may be displaced within the frame 5 to be different distances apart, thereby adapting their position to different hole positions of the bumpers 1 and, thus, to different welding positions 4.1.

Advantageously, one of the telescopic rods in each case is angled or has an adjustable articulated joint 5.1.3. As an alternative, the telescopic rods are advantageously connected to each other via articulated joints 5.1.3.

### LIST OF REFERENCE NUMERALS

1 bumper
1.0 vertical line
1.1 central piece (of the bumper 1)
1.2 end piece (of the bumper 1)
1.3 horizontal line
1.4 hole
2 sensor holder
2.1 hollow cylinder
2.1.1 cylinder axis
2.2 mounting plate
3 workbench
4 holding fixture
4.1 welding position
5 frame
5.1.1 central rod
5.1.2 end rod
5.1.3 articulated joint
5.2.1 hollow cylinder rod
5.2.2 cylinder rod
6 diode laser
7 spacer
7.1 spacer axis
8 hold-down device
8.1 gripper
8.2 hold-down element
9 processing unit
l_{S} bumper length
l_{G} frame length

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A mounting device for simultaneous welding of several sensor holders to a bumper under contact pressure, said bumper having a horizontal line, extending in a mirror-symmetrical manner with respect to a vertical line and having a bumper length, along which horizontal line holes are formed in the bumper, around which each respective sensor holder can be welded simultaneously, and the sensor holders are each formed by a hollow cylinder with a cylinder axis and a mounting plate formed perpendicularly to said cylinder axis, said mounting device comprising
a workbench connected to a holding fixture that is configured for the bumper such that the holes are respectively held in a welding position,
a processing unit which is adjustable to the holding fixture and has as many welding tools as there are welding positions, each welding tool being positioned opposite a respective one of the welding positions in a working position of a frame, wherein said processing unit includes the frame which has a frame length and to which spacers are attached, each having a spacer axis which is perpendicular to the holding fixture in the working position,
hold-down devices being attached to the free ends of the spacers, said welding tools each being formed by at least one freely radiating diode laser arranged above the hold-down device at a respective one of the spacers, the hold-down devices each having a gripper, for insertion into the hollow cylinder of one of the sensor holders and a hold-down element designed to contact the mounting plate thereof, wherein the hold-down element is transparent, at least in some areas, for laser radiation emitted by the at least one diode laser.

2. The mounting device according to claim 1, wherein the hold-down devices are spring-mounted with respect to the spacers.

3. The mounting device according to claim 1, wherein the holding fixture is replaceable by another holding fixture adapted to another bumper with another bumper length and the frame is variable in its frame length, with the spacers being mounted so as to be adjustable on or with the frame.

4. The mounting device according to claim 3, wherein the frame is formed by a central rod and two end rods angled with respect to the central rod.

5. The mounting device according to claim 4, wherein the central rod is connected to each of the end rods by respective articulated joints.

6. The mounting device according to claim 3, wherein the frame is formed by a telescopic rod system comprising several telescopic rods, wherein each telescopic rod comprises a hollow cylinder rod and at least one cylinder rod guided therein.

7. The mounting device according to claim 6, wherein the telescopic rods are connected to each other by respective articulated joints.
